(19) United States
(12) Patent Application Publication
(10) Pub. No.: US 2008/0020917 A1
(43) Pub. Date: Jan. 24, 2008

(54) Method and device for creating a hinge-like bendable zone in a sheet of paper, paperboard, cardboard or foil

(76) Inventor: Jurgen Pohlmann, Luebbecke (DE)

Correspondence Address: ALIX YALE & RISTAS LLP, 750 MAIN STREET, SUITE 1400, HARTFORD, CT, 06103, US

(21) Appl. No.: 11/827,390

(22) Filed: Jul. 11, 2007

(30) Foreign Application Priority Data
Jul. 18, 2006 (DE) DE102006033117.6

(51) Int. Cl. B31F 1/10; B65H 45/16

(52) U.S. Cl. 493/395

(57) ABSTRACT

In a method for producing a hinge-like bend line (3a,b, 4a,b or 5a,b) in a sheet (1) of paper, paperboard, cardboard or foil, particularly a brochure cover, by rotatively driven tools (7.1, 7.2), the bending line (3a,b, 4a,b or 5a,b) is produced by roll bending without scoring the material in the form of a scoring bead. The roll bending is preferably realized by the cooperation of a tool edge (12a) of a first rotary tool member (8.1) with a conical outside surface (11a) of a second rotary tool member (9.1). The roll bending process lowers the bending resistance of the sheet (1) in the region of the bending point (3a,b, 4a,b or 5a,b), wherein the sheet (1) is simultaneously pre-bent in a certain direction along the bending point (3a,b, 4a,b), e.g., in order to take into account the position of the brochure cover on the book block at the spine edges (the sheet is pre-bent inward in a U-shaped fashion).

### BACKGROUND

The present invention pertains to a method and a device for creating a hinge-like bendable zone in a sheet of paper, paperboard, cardboard or foil, particularly a brochure cover, by means of rotatively driven tools.

Methods in which material is compressed and/or displaced are conventionally employed for creating hinge-like bending zones or lines in a sheet of paper, paperboard, cardboard or foil, especially for use in covers for books or brochures (collectively, “cover sheets”). In this case, the sheet is scored along the bending line such that the bending resistance in the bending line is reduced and the stability of the sheet is barely changed.

Various scoring devices with rotatively driven tools are listed on page 116 of the technical book “Industrial Bookbinding” by Dieter Liebau and Inès Heinze, Publishing House Beruf+Schule, 2001. An upper tool in the form of a scoring blade or a scoring disk carries out the scoring process in cooperation with a lower tool that may consist of a sleeve with a circumferential radial groove or be composed of two opposite sleeves with rounded edges, the gap between which is adjustable. It is also known to utilize a scoring blade for directly scoring against a cylindrical rubber roller.

In order to realize the scoring with adequate quality such that a uniform scoring bead is produced and no tearing of the upper and lower sides occurs, the geometric relations (width of the scoring blade, width of the groove in the lower tool and depth of penetration of the scoring blade) need to be adapted to the respective material to be scored. It may even be required to exchange the tools if the product thickness varies significantly.

DE 200 22 488 U1 describes a scoring device in which the scoring blade consists of an elastic ring that is exchangeably accommodated in a groove of the upper tool. The upper tool features several grooves of different widths and depths that are arranged adjacent to one another such that rings of different diameters and/or geometries can be inserted into the upper tool. In addition, the lower tool features a series of adjacently arranged grooves that can be allocated to the respective rings of the upper tool with respect to the material to be scored and the material thickness by means of a color code. In this case, it is disadvantageous that rings need to be exchanged and that the upper and lower tools need to be positioned relative to one another anew in accordance with a predetermined allocation matrix if the material or the material thickness changes, wherein these procedures require a significant set-up effort.

### SUMMARY

The present invention is based on the objective of developing a method and a device for creating a hinge-like bendable line in a sheet of paper, paperboard, cardboard or foil, particularly a brochure cover, i.e., cover sheet, by means of rotatively driven tools, wherein the method and device make it possible to process a broad variety of sheet materials and sheet thicknesses with the same tool set of upper and lower tools and to quickly adjust the device to the respective sheet to be processed. A related objective is improving the additional processing of the processed sheet.

This objective is attained in that the bending line is created by means of roll bending without scoring the material in the form of a scoring bead. The conventional allocation between the scoring blade and the lower tool that serves as the scoring counterpart is eliminated because the sheet material is no longer displaced into a defined groove at the bending point. The roll bending process lowers the bending resistance of the sheet in the region of the bending point, whereby the sheet is simultaneously pre-bent in a certain direction along the bending point, e.g., in order to take into account the position of the brochure cover on the book block at the spine edges (the sheet is pre-bent inward in a U-shaped fashion in this case) or to simplify the opening and closing of the brochure cover on the assembled brochure (the sheet is pre-bent inward or outward in dependence on the desired opening characteristics).

The roll bending is preferably realized by the cooperation of a tool edge of the first rotary tool with a conical outside surface of the second rotary tool such that the respective sheet can be pre-bent in a defined direction. In another variation of the method, the roll bending is realized by the cooperation of essentially complementary conical outside surfaces of the two rotary tools, whereby an edge of one outside surface respectively cooperates with the outside surface of the other rotary tool. This causes the sheet to be bent in opposite directions in the form of a Z-bend such that, for example, a box-shaped brochure cover contour can be realized during the processing of the spine edges.

The objective is attained with a device in which the first rotary tool features a substantially radially projecting tool edge, and the second rotary tool features a conical outside surface that is inclined toward the rotational axis and cooperates with the tool edge of the first rotary cool while it acts upon the sheet.

According to one advantageous embodiment, the radially projecting tool edge has an essentially triangular cross section such that the required stability of the tool edge is ensured. In another advantageous embodiment, the radially projecting tool edge is rounded with a defined radius such that the sheet being processed is provided with a semicircular depression. It is advantageous that the tool edge consists of an elastic material. This enables the tool edge to yield in order to protect the sheet material from being overstressed or destroyed.

In order to realize a desired bending direction, for pre-bending the sheet inward or outward, another advantageous embodiment proposes that the second rotary tool with the outside surface that is inclined toward the rotational axis can be used as upper or as lower tool. The inclination of the outside surface is preferably greater than 30°, wherein an inclination of the outside surface between 45° and 70° proved particularly advantageous.

In another embodiment of the device, both rotary tools feature conical outside surfaces that are essentially inclined in opposite directions and complement one another, wherein a radially projecting edge of one outside surface respectively cooperates with the outside surface of the other rotary tool. The bending point is subjected to uniform pressure over a defined width such that a changed appearance of the bending point is realized in comparison with instances in which the bending point is processed with a single tool edge that cooperates with an outside surface. In addition, the sheet is practically pre-bent in opposite directions in the form of a Z-bend such that a step is realized at the bending point. A box-shaped contour is produced in the sheet due to the processing of a bending point that extends parallel thereto and features a mirror-inverted step, wherein this box-shaped contour is advantageous with respect to the arrangement of a brochure cover sheet on the book block spine. The bending point with a Z-bend is also suitable for use as a folded joint because the respective bends of the Z-bend essentially neutralize one another.

In another advantageous embodiment, both rotary tools can be adjusted relative to one another in the axial direction. This means that the rotary tools can be adjusted to the respective sheet thickness or that the degree of material compression can be adapted to the properties of the sheet material. It is furthermore advantageous that the axial spacing between the two rotary tools is adjustable such that it is possible, for example, to influence the shape of the Z-bend.

### BRIEF DESCRIPTION OF THE DRAWING

The characteristics of preferred embodiments of the present invention are described in greater detail below with reference to the accompanying drawing in which:

FIG. 1 is a sectional representation of a first embodiment of an inventive roll bending device;

FIG. 1a shows a detail of the roll bending processing zone in FIG. 1;

FIG. 2 is a sectional representation of a second embodiment of a roll bending device;

FIG. 2a shows a detail of the roll bending processing zone in FIG. 2, and

FIG. 3 shows a roll bending device according to FIG. 1, in which the arrangement of the rotary tools is reversed.

### DETAILED DESCRIPTION

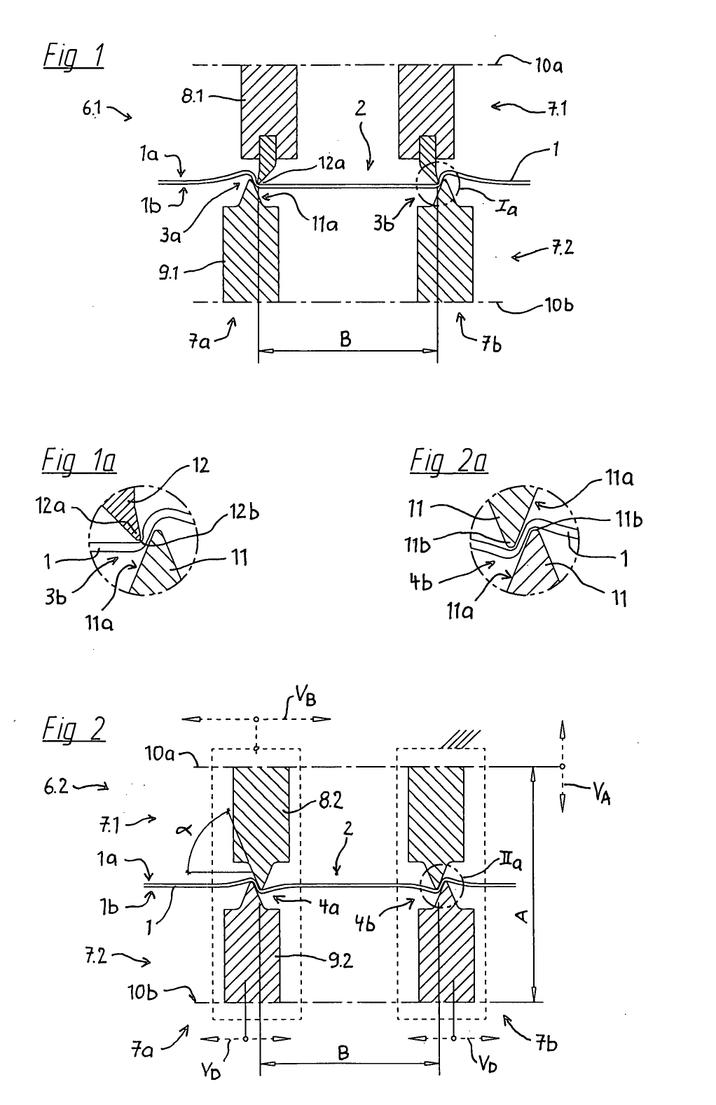

FIG. 1 shows a roll bending device 6.1 for producing hinge-like bending lines 3a,b that border the spine region 2 in a cover sheet 1, for e.g., printed products such as books and brochures. The cover sheet 1 is respectively bent inward referred to its inner and its outer side 1a and 1b along bending lines 3a,b such that the spine region 2 is realized with a U-shaped cross section and the cover sheet 1 can be advantageously attached to a glued book block spine in a flawless fashion during the additional processing that is not illustrated in greater detail.

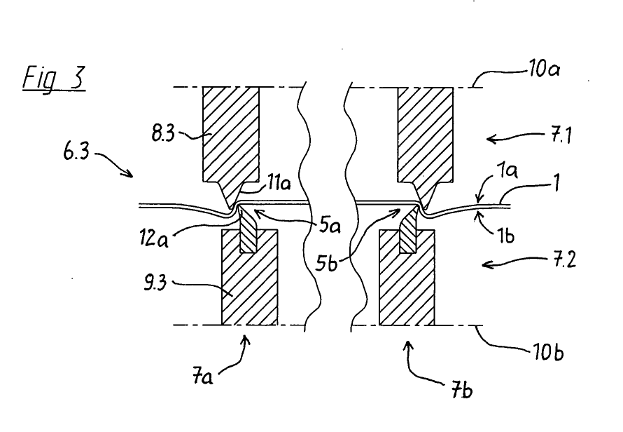

FIG. 2 shows an alternative roll bending device 6.2 that makes it possible to realize the cover sheet 1 with a box-shaped contour in the spine region 2, namely by bordering the spine region 2 with bending lines 4a,b that are respectively bent in a Z-shaped fashion. FIG. 3 shows a roll bending device 6.3 that is reversed in comparison with the variation shown in FIG. 1 and serves for realizing outwardly bent bending lines 5a,b that preferably form hinges of the front and the rear cover and are positioned at a defined distance from the spine region 2.

The disclosed roll bending devices 6.1 to 6.3 respectively consist of left and right pairs 7a,b of roll bending tools that are respectively realized and arranged in a mirror-inverted fashion, wherein these pairs of roll bending tools are spaced apart by the spine width B in the embodiments shown in FIGS. 1 and 2. Each pair 7a and b of roll bending tools features an upper tool 7.1 and a lower tool 7.2. The tools 7.1 and 7.2 are rotatively driven in opposite directions, wherein their rotational axes 10a and b are spaced apart from one another by an axial distance A.

In the roll bending device 6.1 according to FIG. 1, the upper tool 7.1 has a first rotary tool member 8.1 with a circumferentially projecting ring 12, the circumferential tool edge 12a of which is rounded with a defined radius 12b. The lower tool 7.2 has a second rotary tool member 9.1 with a conical outside surface 11a that is inclined toward the rotational axis 10b and features a projection 11a of triangular cross section.

The tool edge 12a of the first rotary tool member 8.1 cooperates with the inclined, conical outside forming surface 11a of the second rotary tool member 9.1, whereby the continuously transported cover sheet 1 lying therebetween is deformed in accordance with the roll bending principle. In this context, “conical” should be understood as exemplified by the inclined, substantially frustoconical surface 11a observable as, e.g., the left rotary tool 9.1 is viewed along the rotational axis 10b from the spine region 2.

In this embodiment, the inclination a of the outside forming surface 11a relative to the rotational axis 10b amounts to approximately 67.5°, but it should be noted in this context that the tools may be realized with any angle α between 30° and 90°.

The detail shown in FIG. 1a elucidates how the cover sheet 1 is compressed by the tool edge 12a in the bending line 3b cooperatively working against the confronting tool surface 11a, wherein a chamfer of sorts is produced in the cover sheet 1 due to the inclined outside forming surface 11a that acts as a counter bearing. The tool edge 12a projects substantially radially relative to axis 10a into confronting relationship with the inclined forming surface 11a either transversely (FIG. 1a) or substantially in parallel (FIG. 2a). These edges or inclined surfaces can have a curvature.

As mentioned above, FIG. 3 shows a roll bending device 6.3 that is reversed in comparison with the embodiment shown in FIG. 1. In this case, the rotary tool member 8.3 that serves as the upper tool 7.1 has the inclined outside forming surface 11a while the rotary tool member 9.3 used as the lower tool 7.2 features the tool edge 12a.

In the second embodiment of the roll bending device 6.2 shown in FIG. 2, rotary tool members 8.2 and 9.2 that are essentially realized identically are used as upper and lower tools 7.1 and 7.2. The rotary tool members 8.2 and 9.2 respectively feature a projection 11 of triangular cross section analogous to that described above with reference to the rotary tool members 9.1 and 8.3. The two outside forming surfaces 11a are inclined in a complementary fashion such that the rotary tool members 8.2 and 9.2 with their outside surfaces 11a can be adjusted relative to one another. In this context, see the detail illustrated in FIG. 2a.

The revolving projecting edge of one rotary tool member 8.2 or 9.2 respectively cooperates with the outside forming surface 11a of the other rotary tool member 9.2 or 8.2 in the form of a radiused tool edge 11b in this case. The cover sheet 2 is bent inward once along the bending line 4a or 4b and bent outward again once directly adjacent thereto such that a bending point of essentially Z-shaped cross section is produced.

In the embodiment shown in FIG. 2, the right pair 7b of roll bending tools is arranged stationarily while the left pair 7a of roll bending tools can be adjusted with respect to the spine width B as symbolically indicated with the reference symbol V_{B}.

Another adjustment V_{A} can be realized by varying the axial distance A between the two tools 7.1 and 7.2. This adjustment makes it possible to vary the working position of the tool edge 12a on the outside forming surface 11a. In the second embodiment of the roll bending device 6.2 shown in FIG. 2, this makes it possible to vary the distance between the two oppositely directed chamfers in the bending line 4a,b or its compressed surface in the cover sheet, respectively. In this context, see FIG. 2a.

In addition, it is possible to realize an adjustment V_{D} of each pair 7a and b of roll bending tools in order to adjust the processing distance of the tool edge 12a (or 11b) relative to the corresponding outside forming surface 11a in the sense of a basic setting. This also makes it possible, in principle, to realize a defined adjustment of the cover sheet thickness.

However, an adjustment V_{D} of the processing distance as well as an adjustment V_{A} of the axial distance A is not required during the normal operation of an inventive roll bending device 6.1 to 6.3 of this type. Various cover sheet materials and thicknesses can be processed with one and the same adjustment of the pairs 7a and b of roll bending tools. Bending lines 3a,b, 4a,b or 5a,b of adequate quality are produced in all instances, wherein these bending lines are characterized in that they bend easily and feature no torn surfaces.

In order to carefully process the cover sheet 1, the ring 12 and therefore the tool edge 12a may consist of an elastic material. However, it was determined that hard tool edges 12a and outside surfaces 11 are advantageous with respect to producing high-quality bending lines 3a,b, 4a,b or 5a,b in a multitude of different sheet materials.

1. In a method for producing a hinge-like bending line in a cover sheet using rotary tools, the improvement wherein the bending line is produced by roll bending the sheet without scoring the sheet with a scoring bead.

2. The method according to claim 1, wherein the roll bending is realized by a tool edge of a first rotary tool member working against a conically shaped forming surface of a second rotary tool member in combined action on the sheet.

3. The method according to claim 2, wherein the roll bending is realized by the combined action of essentially complementary conical forming surfaces of said first and second rotary tool members, whereby an edge of one conical surface respectively cooperates with an inclined conical forming surface of the other rotary tool member.

4. A device for producing a hinge-like bending line in a cover sheet, comprising:
upper and lower tools having respective first and second rotary tool members driven in opposite directions;
said first rotary tool member having a projecting tool edge, and said second rotary tool member having an outside forming surface that is inclined relative to the rotational axis;
wherein the projecting edge of the first rotary tool member confronts and cooperates with the outside forming surface to produce a bend line on a cover sheet passing there between.

5. The device according to claim 4, wherein the projecting tool edge has a substantially triangular cross section.

6. The device according to claim 4, wherein the projecting tool edge is rounded with a defined radius.

7. The device according to claim 6, wherein the projecting tool edge consists of elastic material.

8. The device according to claim 4 wherein the second rotary tool member with the inclined outside surface is situated vertically below the first rotary tool member with projecting tool edge.

9. The device according to one of claim 4 wherein the inclination of the outside forming surface relative to the rotational axis of the second tool member, is greater than 30°.

10. The device according to claim 9, wherein the inclination of the outside surface lies between the 45° and 70°.

11. The device according to claim 4 wherein both rotary tool members have respective forming surfaces that are inclined in opposite directions and substantially complement one another, whereby a substantially radially projecting edge of one forming surface respectively cooperates with the forming surface of the other rotary tool member.

12. The device according to claim 4 wherein both rotary tools can be adjusted relative to one another along their rotation axes.

13. The device according to claim 4 wherein the perpendicular distance between the rotation axes of the rotary tools is adjustable.

14. The device according to claim 5, wherein the projecting tool edge is rounded with a defined radius.

15. The device according to claim 14, wherein the projecting tool edge consists of elastic material.

16. The device according to claim 4 wherein the second rotary tool member with the inclined outside surface is situated vertically above the first rotary tool member with projecting tool edge.

17. The device according to claim 5 wherein the second rotary tool member with the inclined outside surface is situated vertically below the first rotary tool member with projecting tool edge.

18. The device according to claim 5 wherein the second rotary tool member with the inclined outside surface is situated vertically above the first rotary tool member with projecting tool edge.

19. The device according to claim 4 wherein the tool edge of the first rotary tool member projects substantially radially from the rotation axis of the first rotary tool member.
